(19) United States
(12) Patent Application Publication
(10) Pub. No.: US 2018/0242230 A1
(43) Pub. Date: Aug. 23, 2018

(54) SWITCHING BETWEEN UNICAST SERVICE AND MULTICAST-BROADCAST SERVICE

(71) Applicants: Edward Grinshpun, Freehold, NJ (US); Tomas S. Young, Parsippany, NJ (US); Alvaro Villegas Nunez, Madrid (ES)

(72) Inventors: Edward Grinshpun, Freehold, NJ (US); Tomas S. Young, Parsippany, NJ (US); Alvaro Villegas Nunez, Madrid (ES)

(73) Assignees: Alcatel-Lucent USA Inc., Murray Hill, NJ (US); Alcatel-Lucent Espana S.A.

(21) Appl. No.: 15/436,809

(22) Filed: Feb. 19, 2017

(51) Int. Cl. H04W 48/16; H04W 4/06; H04W 76/02

(52) U.S. Cl. CPC H04W 48/16; H04L 12/189; H04W 76/021; H04W 4/06

(57) ABSTRACT

The present disclosure generally discloses improvements in computer performance for delivery of content via a wireless communication network. The present disclosure generally discloses improvements in computer performance for delivery of content to wireless end devices via a wireless communication network using unicast services and multicast-broadcast services of the wireless communication network based on a service switching capability configured to support dynamic and opportunistic switching between the unicast services and multicast-broadcast services of the wireless communication network. The service switching capability may be configured to support dynamic and opportunistic switching between use of unicast service and use of multicast-broadcast service for a content item on a serving cell based on a number of wireless end devices on the serving cell that are receiving or requesting the content item.

### TECHNICAL FIELD

The present disclosure relates generally to communication networks and, more particularly but not exclusively, to improvements in computer performance for delivery of content via wireless communication networks.

### BACKGROUND

Many types of wireless communication networks are configured to support unicast service and multicast-broadcast service.

### SUMMARY

The present disclosure generally discloses improvements in computer performance for supporting delivery of content to wireless end devices via a wireless communication network, including delivery of content to wireless end devices via a wireless communication network using unicast and multicast-broadcast services of the wireless communication network based on dynamic and opportunistic switching between unicast and multicast-broadcast services of the wireless communication network.

In at least some embodiments, an apparatus is provided. The apparatus includes a processor and a memory communicatively connected to the processor. The processor is configured to receive, by a content delivery system from a wireless end device, a request for a content item available from the content delivery system. The processor is configured to determine, by the content delivery system, a serving cell identifier of a serving cell with which the wireless end device is associated. The processor is configured to determine, by the content delivery system based on the serving cell identifier of the serving cell with which the wireless end device is associated, whether the request for the content item is to be served by the serving cell using a unicast service or using a multicast-broadcast service. In at least some embodiments, a non-transitory computer-readable storage medium stores instructions which, when executed by a computer, cause the computer to perform a corresponding method for supporting delivery of content to wireless end devices. In at least some embodiments, a corresponding method for supporting delivery of content to wireless end devices is provided.

In at least some embodiments, an apparatus is provided. The apparatus includes a processor and a memory communicatively connected to the processor. The processor is configured to receive, at a multicast-broadcast controller from a content delivery system, a request to activate use of a multicast-broadcast service for a content item on a serving cell of a wireless communication network. The processor is configured to activate, by the multicast-broadcast controller based on the request, use of the multicast-broadcast service for the content item on the serving cell. The processor is configured to send, from the multicast-broadcast controller toward the content delivery system, a response indicative that use of the multicast-broadcast service for the content item has been activated on the serving cell for the content item. In at least some embodiments, a non-transitory computer-readable storage medium stores instructions which, when executed by a computer, cause the computer to perform a corresponding method for supporting delivery of content to wireless end devices. In at least some embodiments, a corresponding method for supporting delivery of content to wireless end devices is provided.

In at least some embodiments, an apparatus is provided. The apparatus includes a processor and a memory communicatively connected to the processor. The processor is configured to send, from a wireless end device toward a content delivery system via a serving cell of a wireless communication network, a request for a content item. The processor is configured to receive, by the wireless end device from the content delivery system via the serving cell, a response to the request for the content item. The processor is configured to determine, by the wireless end device based on the response to the request for the content item, whether to obtain the content item using a unicast service or a multicast-broadcast service. In at least some embodiments, a non-transitory computer-readable storage medium stores instructions which, when executed by a computer, cause the computer to perform a corresponding method for supporting delivery of content to wireless end devices. In at least some embodiments, a corresponding method for supporting delivery of content to wireless end devices is provided.

In at least some embodiments, an apparatus is provided. The apparatus includes a processor and a memory communicatively connected to the processor. The processor is configured to determine, by a wireless end device associated with a serving cell of a wireless communication system and including a content application client, a serving cell identifier of the serving cell. The processor is configured to send, from the wireless end device toward a content delivery system including a content application server, a content application message comprising an indication of the serving cell identifier of the serving cell. In at least some embodiments, a non-transitory computer-readable storage medium stores instructions which, when executed by a computer, cause the computer to perform a corresponding method for supporting delivery of content to wireless end devices. In at least some embodiments, a corresponding method for supporting delivery of content to wireless end devices is provided.

### BRIEF DESCRIPTION OF THE DRAWINGS

The teachings herein can be readily understood by considering the following detailed description in conjunction with the accompanying drawings, in which:

FIG. 1 depicts an example wireless communication architecture that is configured to support delivery of content to wireless end devices based on unicast services and multicast-broadcast services of a wireless communication network;

FIG. 2 depicts a method, based on the wireless communication architecture of FIG. 1, which is configured to support delivery of content to wireless end devices based on unicast services and multicast-broadcast services of a wireless communication network;

FIG. 3 depicts a method for use by a wireless end device in supporting delivery of content to the wireless end device based on unicast services and multicast-broadcast services of a wireless communication network;

FIG. 4 depicts a method for use by a content delivery system in supporting delivery of content to a wireless end device based on unicast services and multicast-broadcast services of a wireless communication network;

FIG. 5 depicts a method for use by a multicast-broadcast controller in supporting delivery of content to a wireless end device based on unicast services and multicast-broadcast services of a wireless communication network; and

FIG. 6 depicts a high-level block diagram of a computer suitable for use in performing various functions presented herein.

To facilitate understanding, identical reference numerals have been used, where possible, to designate identical elements that are common to the figures.

### DETAILED DESCRIPTION

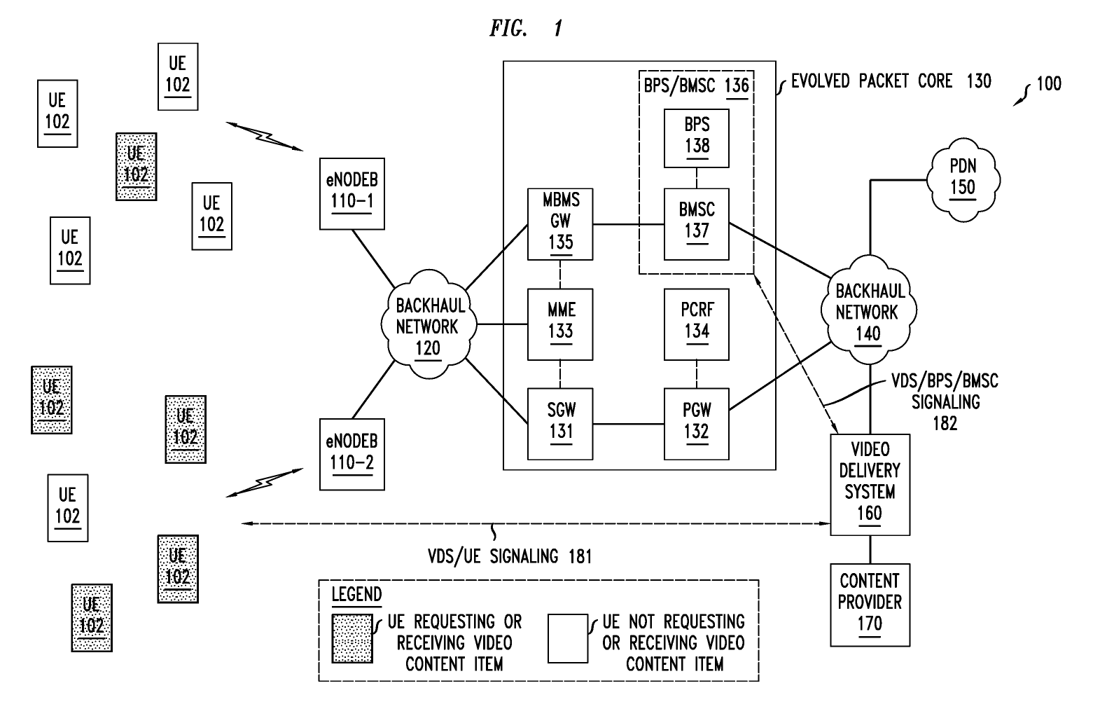

The present disclosure generally discloses improvements in computer performance for supporting delivery of content to wireless end devices via a wireless communication network. The present disclosure generally discloses improvements in computer performance for supporting delivery of content to wireless end devices via a wireless communication network using unicast and multicast-broadcast services of the wireless communication network based on a service switching capability configured to support dynamic and opportunistic switching between the unicast and multicast-broadcast services of the wireless communication network. The service switching capability may be configured to support dynamic and opportunistic switching between use of unicast service and use of multicast-broadcast service for a content item on a serving cell based on a number of wireless end devices on the serving cell that are receiving or requesting the content item (e.g., using unicast service to deliver the content item within the serving cell while the number of wireless end devices on the serving cell that have received or requested the content item fails to satisfy a threshold and using multicast-broadcast to deliver the content item within the serving cell while the number of wireless end devices on the serving cell that have received or requested the content item satisfies a threshold, thereby improving or tending to improve use of wireless resources of the wireless network). The service switching capability may be configured to support dynamic and opportunistic switching between use of unicast service and use of multicast-broadcast service for a content item on a serving cell based on control over dynamic and opportunistic switching between use of unicast service and use of multicast-broadcast service by a content delivery system from which the content item is available. The service switching capability may be configured to support dynamic and opportunistic switching between use of unicast service and use of multicast-broadcast service for a content item on a given serving cell based on signaling by the content delivery system with a multicast-broadcast controller that is configured to activate and deactivate use of multicast-broadcast service for the content item on individual serving cells and based on signaling by the content delivery system with wireless end devices (e.g., for controlling whether the wireless end device uses unicast service or multicast-broadcast service to receive the content item). The service switching capability may be configured to support dynamic and opportunistic switching between use of unicast service and use of multicast-broadcast service for a content item on a serving cell by making the content delivery system aware of serving cell information of the wireless end devices and enabling the content delivery system to track the number of wireless end device receiving or requesting the content item via the serving cell. It will be appreciated that various embodiments of the service switching capability may be configured to support switching between use of unicast service and use of multicast-broadcast service for various types of content (e.g., data, audio content, video content, virtual reality content, augmented reality content, or the like); however, for purposes of clarity, embodiments of the service switching capability are primarily presented herein with respect to supporting switching between use of unicast service and use of multicast-broadcast service for video content (and, more particularly, live video content). It will be appreciated that these and various other embodiments and advantages or potential advantages of the service switching capability may be further understood by way of reference to the example wireless communication architecture of FIG. 1.

FIG. 1 depicts an example wireless communication architecture configured to support delivery of content to wireless end devices based on unicast services and multicast-broadcast services of a wireless communication network.

The wireless communication architecture 100 is based on Fourth Generation (4G) Long Term Evolution (LTE) wireless technologies. It will be appreciated that, although primary presented herein within the context of an LTE-based wireless communication network, various embodiments presented herein may be used within, or adapted for use within, various other types of wireless communication networks (e.g., Third Generation (3G) wireless networks, other types of 4G wireless networks, Fifth Generation (5G) wireless networks, or the like).

The wireless communication architecture 100 includes a set of User Equipments (UEs) 102, a pair of evolved NodeBs (eNBs) 110-1 and 110-2 (collectively, eNBs 110), a backhaul network (BN) 120, an Evolved Packet Core (EPC) 130, a backhaul network (BN) 140, a packet data network (PDN) 150, a video delivery system (VDS) 160, and a content provider (CP) 170.

The UEs 102 are wireless end devices. The UEs 102 are configured to communicate with the eNBs 110 wirelessly. The UEs 102 are configured to request, receive, and present content. The content may include data content, audio content, video content (e.g., pure video, multimedia including audio and video, or the like), virtual reality content, augmented reality content, or the like. The UEs 102 may be configured to receive content via unicast service, multicast-broadcast service, or the like, as well as various combinations thereof. The UEs 102 may support respective video application clients configured to communicate with a video application server of the VDS 160 at the application layer (e.g., for requesting content items, for requesting segments of content items, for receiving instructions regarding the type of service to be used to receive content items, or the like, as well as various combinations thereof). The UEs 102, for example, may include wireless end user devices (e.g., smartphones, tablet computers, laptop computers, or the like), wireless Machine Type Communication (MTC) devices (e.g., Internet-of-Things (IoT) devices or other MTC devices), or the like, as well as various combinations thereof. The UEs 102, as discussed further below, may be configured to provide various function supporting the service switching capability in order to enable dynamic switching between use of unicast service and use of eMBMS service for a given content item on a given eNB 110 based on a number of UEs 102 served by the eNB 110 that have received or requested the given content item.

The eNBs 110 are wireless access devices. The eNBs 110 support wireless interfaces by which the UEs 102 may communicate with the eNBs 110 wirelessly. The eNBs 110 are support communications with the BN 120, for support communication of information between the UEs 102 and upstream devices (e.g., elements of EPC 130, devices located within or accessible via PDN 150, VDS 160, or the like). The eNBs 110 are configured to support delivery of content to UEs 102 using unicast services, multicast-broadcast services (referred to in LTE as Enhanced Multimedia Broadcast Multicast Services (eMBMSs), or the like, as well as various combinations thereof.

The BN 120 is a backhaul network. The BN 120 is configured to support backhaul of communications (e.g., signaling, data, or the like, as well as various combinations thereof) between the UEs 102 and the EPC 130. The BN 120 may be any suitable type of backhaul network, which may be based on various types of backhaul technologies (e.g., Ethernet, Multiprotocol Label Switching (MPLS), optical, or the like, as well as various combinations thereof).

The EPC 130 is configured to provide core wireless network functions. The EPC 130 includes a Serving Gateway (SGW) 131, a PDN Gateway (PGW) 132, a Mobility Management Entity (MME) 133, a Policy and Charging Rules Function (PCRF) 134, a Multimedia Broadcast Multicast Service (MBMS) gateway (GW) 135, and a Broadcast Provisioning Server (BPS)/Broadcast Multicast Service Center (BMSC) 136 which includes a BMSC 137 and a BPS 138). The typical operation of the elements of EPC 130 will be understood by one of ordinary skill in the art. The BPS/BMSC 136, as discussed further below, may be configured to provide various function supporting the service switching capability in order to enable dynamic switching between use of unicast service and use of eMBMS service for a given content item on a given eNB 110 based on a number of UEs 102 served by the eNB 110 that have received or requested the given content item.

The BN 140 is a backhaul network. The BN 140 is configured to support backhaul of communications (e.g., signaling, data, or the like, as well as various combinations thereof) between EPC 130 and the PDN 150. The BN 140 also is configured to provide connectivity for the VDS 160, such that the VDS 160 may communicate with various elements (e.g., UEs 102 via the EPC 130, elements of EPC 130, or the like, as well as various combinations thereof). The BN 140 may be any suitable type of backhaul network, which may be based on various types of backhaul technologies (e.g., Ethernet, MPLS, optical, or the like, as well as various combinations thereof).

The PDN 150 is a packet data network or multiple packet data networks. For example, the PDN 150 may include one or more public packet data networks (e.g., the Internet), one or more private packet data networks (e.g., one or more enterprise networks, one or more datacenter networks, or the like), or the like, as well as various combinations thereof).

The VDS 160 is a video delivery system. The VDS 160 is configured to support delivery of content items (which may be made available to the VDS 160 by the CP 170). The VDS 160 may be configured to support delivery of content items to UEs 102 via BN 140, EPC 130, BN 120, and eNBs 111. The VDS 160 may be configured to support delivery of content items to UEs 102 using a single content item version per content item, using multiple content item versions per content item (e.g., using adaptive streaming technologies, such as Hypertext Transfer Protocol (HTTP) Adaptive Streaming (HAS) or other types of Adaptive Bitrate Streaming (ABR) technologies), or the like, as well as various combinations thereof. The VDS 160 may include or have access to content storage elements (e.g., disks, caches, or the like) which may store the content items which may be delivered by the VDS 160. The VDS 160 may support a video application server configured to communicate with the video application clients of UEs 102 at the application layer (e.g., for receiving requests for content items, for receiving requests for segments of content items, for sending instructions regarding the type of service to be used to receive content items, or the like, as well as various combinations thereof). The VDS 160, as discussed further below, may be configured to provide various function supporting the service switching capability in order to enable dynamic switching between use of unicast service and use of eMBMS service for a given content item on a given eNB 110 based on a number of UEs 102 served by the eNB 110 that have received or requested the given content item.

The CP 170 is a content provider. The CP 170 is configured to create or obtain the content items and provide the content items to the VDS 160 for use by the VDS 160 in serving requests for the content items from the UEs 102.

The wireless communication architecture 100 may be configured to support a service switching capability enabling dynamic and opportunistic switching between use of unicast service (e.g., LTE unicast) and use of multicast-broadcast service (e.g., LTE eMBMS) for a content item on a serving cell (e.g., eNB 110) based on a number of wireless end devices (e.g., UEs 102) that have received or requested the content item. As noted above, the VDS 160, the BPS/BMSC 136, and the UEs 102 each may be configured to support various functions and signaling, respectively, in order to support dynamic and opportunistic switching between use of unicast service and use of multicast-broadcast service for a content item on a serving cell.

The VDS 160 may be configured to support various functions and signaling in order to support dynamic and opportunistic switching between use of unicast service and use of multicast-broadcast service for a content item on a serving cell.

The VDS 160 is expected to have content item information as to which UEs 102 are receiving which content items (e.g., IP addresses of the UEs 102 that are receiving or requesting the content item), but may not have serving cell information indicative as to the serving cells with which the UEs 102 are associated (e.g., information that is typically maintained or available from the wireless network). The VDS 160 may be configured to obtain the serving cell information as to the serving cells with which the UEs 102 are associated. The VDS 160 may be configured to obtain the serving cell information from messages received from the UEs 102 (e.g., content item request messages in which the UEs 102 request the content item (e.g., the request for the manifest file for a video content item), content segment request messages in which the UEs 102 request segments of the content item (e.g., each content segment request message, every other content segment request message, the first content segment request message after the UE 102 changes its serving cell, or the like, as well as various combinations thereof), content item termination messages in which the UEs 102 indicate that the content item is no longer wanted, or the like, as well as various combinations thereof), from the network (e.g., based on information received from one or more elements of the network, such as the eNBs 110, one or more elements of EPC 130, or the like, as well as various combinations thereof), or the like, as well as various combinations thereof (e.g., obtained from the network when not received from the UE 102). The VDS 160 may be configured to use the serving cell information of the UEs 102 to dynamically and opportunistically control delivery of content items to UEs 102 using unicast service and eMBMS service.

The VDS 160 may be configured to use the serving cell information of the UEs 102 to control, for each content item and each serving cell, whether the content item is delivered within the serving cell using unicast service or eMBMS service. The VDS 160 may be configured to use the serving cell information of the UEs 102 to monitor, for each content item and each serving cell, the number of UEs 102 receiving or requesting the content item via the serving cell. The VDS 160 may be configured to determine, for a content item and a serving cell, based on the monitoring of the number of UEs 102 receiving or requesting the content item via the serving cell, whether to switch between use of unicast service for the content item in the serving cell and use of eMBMS service for the content item in the serving cell. The VDS 160 may be configured to determine whether to switch between use of unicast service and eMBMS service for a content item in a serving cell based on evaluation of the number of UEs 102 receiving or requesting the content item via the serving cell with respect to a threshold. The threshold may be configured to improve or at least to tend to improve use of wireless resources (e.g., by not wasting wireless resources on multicast transmission when there are not enough UEs 102 to provide wireless resource savings over the wireless resources that would be consumed if the UEs 102 were to receive the content item via unicast transmissions). The VDS 160 may be configured to control, for a content item and a serving cell, switching between use of unicast service for the content item in the serving cell and use of eMBMS service for the content item in the serving cell by dynamically instructing BPS/BMSC 136 to activate and deactivate use of the eMBMS service for the content item in the serving cell and dynamically instructing UEs 102 to switch between use of unicast service for the content item in the serving cell and use of eMBMS service for the content item in the serving cell. The VDS 160 may be configured to use the serving cell information of the UEs 102 to control delivery of content items to UEs in response to various events and conditions.

The VDS 160 may be configured to use the serving cell information of the UEs 102 to handle requests for content items from the UEs 102. The VDS 160 may receive a request for a content item from a UE 102. The VDS 160 may determine the serving cell identifier of the serving cell with which the UE 102 is associated. The VDS 160 may determine whether use of the eMBMS service is active within the serving cell for the content item (e.g., whether an eMBMS flow is active for the content item). The VDS 160, based on a determination that use of the eMBMS service is active within the serving cell for the content item, may respond to the UE 102 with an instruction for the UE 102 to receive the content item using the eMBMS service (e.g., via the eMBMS flow transporting the requested content item). The VDS 160, based on a determination that use of the eMBMS service is not active within the serving cell for the content item, may determine a number of UEs 102 receiving or requesting the content item via the serving cell, determine whether to switch from use of unicast service for the content item in the serving cell to use of eMBMS service for the content item in the serving cell based on the number of UEs 102 receiving or requesting the content item via the serving cell. The VDS 160, based on a determination not to switch from use of unicast service for the content item in the serving cell to use of eMBMS service for the content item in the serving cell, may respond to the UE 102 with an instruction for the UE 102 to receive the content item using unicast service. The VDS 160, based on a determination to switch from use of unicast service for the content item in the serving cell to use of eMBMS service for the content item in the serving cell, may instruct the BPS/BMSC 136 to activate use of the eMBMS service for the content item in the serving cell, respond to the UE 102 with an instruction for the UE 102 to receive the content item using the eMBMS service, and instruct other UEs 102 of the serving cell that are currently receiving the content item via unicast service to switch to receiving the content item using the eMBMS service.

The VDS 160 may be configured to use the serving cell information of the UEs 102 to handle other types of events and conditions associated with delivery of content items to the UEs 102. The VDS 160 may be configured to determine, for a content item and a serving cell, based on the monitoring of the number of UEs 102 receiving or requesting the content item via the serving cell, whether to switch between use of unicast service for the content item in the serving cell and use of eMBMS service for the content item in the serving cell responsive to requests for segments of the content item from the UEs 102 in the serving cell, responsive to an indication that a UE 102 has migrated into or out of the serving area, responsive to expiration of a time period, or the like, as well as various combinations thereof. The VDS 160, based on a determination to switch from use of eMBMS service for the content item in the serving cell to use of unicast service for the content item in the serving cell, may instruct the BPS/BMSC 136 to deactivate use of the eMBMS service for the content item in the serving cell and may instruct any UEs 102 of the serving cell that are currently receiving the content item to switch to receiving the content item using unicast service. It will be appreciated that other types of events or conditions may trigger switches between use of unicast service for the content item in the serving cell and use of eMBMS service for the content item in the serving cell.

The VDS 160 may be configured to use certain external information (e.g., information other than the serving cell information of the UEs 102) to handle various types of events and conditions (e.g., requests for content items from the UEs 102, requests for segments of the content item from the UEs 102, migration events in which UEs 102 migrate into or out of the serving area, or the like) responsive to which the VDS 160 may control whether a content item is delivered within the serving cell using unicast service or eMBMS service. For example, such external information may include one or more of content item popularity information (e.g., indicative of the relative popularity of content items), network congestion information, information indicative of operator needs, or the like, as well as various combinations thereof. It will be appreciated that VDS 160 may use such external information in conjunction with or in place of the serving cell information of the UEs 102 in order to control whether a content item is delivered within the serving cell using unicast service or eMBMS service.

The VDS 160 is configured to support additional types of signaling, including signaling 181 between the VDS 160 and the UEs 102 (e.g., for receiving application messages of the UEs 102 related to obtaining content items from the VDS, for dynamically instructing the UEs 102 to switch between use of unicast service and use of eMBMS service, or the like, as well as various combinations thereof) and signaling 182 between the VDS 160 and the BPS/BMSC 136 (e.g., for dynamically instructing BPS/BMSC 136 to activate and deactivate use of the eMBMS service, for receiving information related to activation and deactivation of use of the eMBMS service such that the VDS 160 may provide instructions to UEs 102 for controlling switching of UEs 102 between use of unicast service and use of eMBMS service, or the like, as well as various combinations thereof).

The VDS 160 may be configured to support various other functions and signaling in order to support dynamic and opportunistic switching between use of unicast service and use of multicast-broadcast service for a content item on a serving cell.

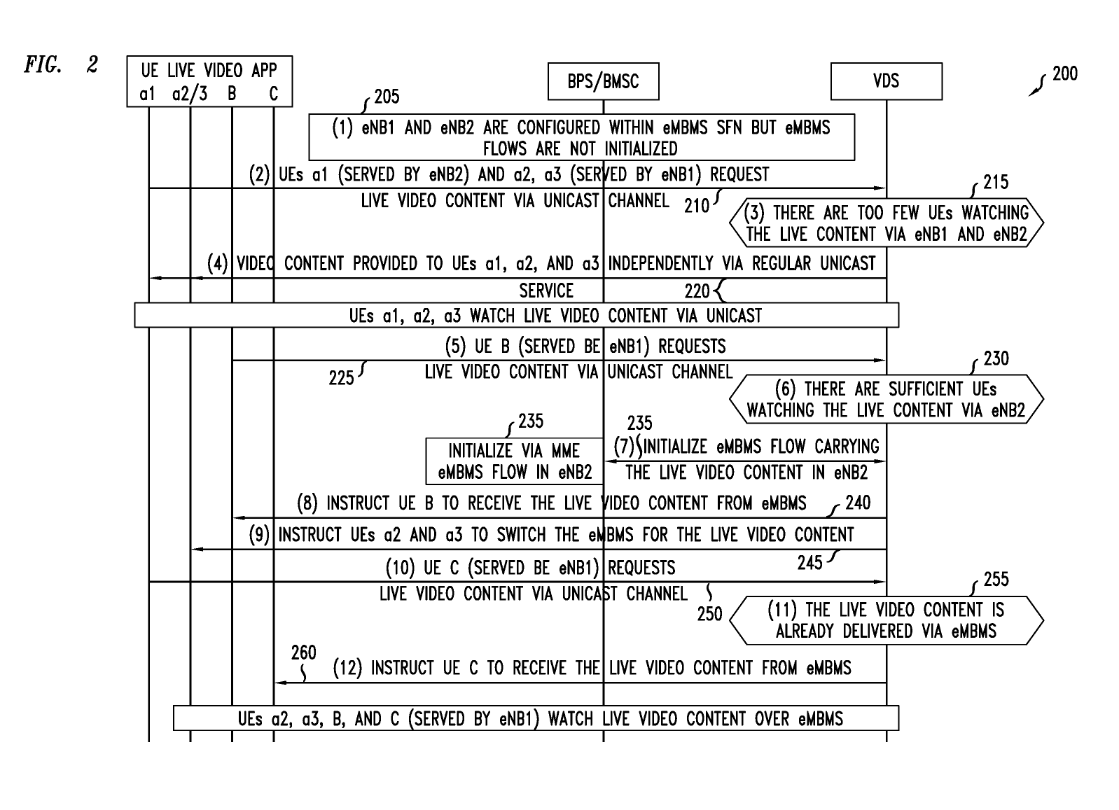

It is noted that the operation of VDS 160 may be further understood by way of reference to the example method of FIG. 2.

The BPS/BMSC 136 may be configured to support various functions and signaling in order to support dynamic and opportunistic switching between use of unicast service and use of multicast-broadcast service for a content item on a serving cell. The BPS/BMSC 136 is expected to have eMBMS membership information as to which UEs 102 are subscribed to and receiving data from eMBMS channels, but is not expected to have information indicative as to which content items are being provided over the eMBMS channels. The BPS/BMSC 136 is configured to control activation and deactivation of use of the eMBMS service on a serving cell based on an instruction from the VDS 160. The BPS/BMSC 136 is configured to, responsive to an instruction from the VDS 160 to activate use of the eMBMS service on a serving cell, activate use of the eMBMS service on the serving cell (e.g., by activating an eMBMS flow for the content item) and provide the VDS 160 with an indication that use of the eMBMS service has been activated on the serving cell and with an indication of the eMBMS channel identifier of the eMBMS channel that is supporting the eMBMS service for the content item (e.g., the eMBMS channel in which the eMBMS flow of the content item was activated). The BPS/BMSC 136 is configured to support the signaling 182 between the VDS 160 and the BPS/BMSC 136 (e.g., for use by the VDS 160 in dynamically instructing the BPS/BMSC 136 to activate and deactivate use of eMBMS service for a content item on serving cells). The BPS/BMSC 136 may be configured to support various other functions and signaling in order to support dynamic and opportunistic switching between use of unicast service and use of multicast-broadcast service for a content item on a serving cell. It is noted that the operation of BPS/BMSC 136 may be further understood by way of reference to the example method of FIG. 2.

The UEs 102 may be configured to support various functions and signaling in order to support dynamic and opportunistic switching between use of unicast service and use of multicast-broadcast service for a content item on a serving cell. A UE 102 may be configured to determine the serving cell identifier of the serving cell with which the UE 102 is associated and include an indication of the serving cell identifier of the serving cell in messages sent from the UE 102 to the VDS 160 (e.g., a content item request messages in which the UE 102 requests the content item (e.g., the request for the manifest file for a video content item), content segment request messages in which the UE 102 request segments of the content item (e.g., each content segment request message, every other content segment request message, the first content segment request message after the UE 102 changes its serving cell, or the like, as well as various combinations thereof), content item termination messages in which the UE 102 indicates that the content item is no longer wanted, or the like, as well as various combinations thereof). The serving cell identifier may be sent by the UE 102 in application layer messages of the video content application supported by the UE 102 and the VDS 160 (which also may be referred to herein as a video content delivery application as it may be configured to support delivery of video content from the VDS 160 to the UE 102). A UE 102 may be configured to receive from the VDS 160 instructions as to whether to use unicast service to receive the content item or whether to use eMBMS service to receive the content item (e.g., in an initial response message from the VDS 160 when the UE 102 initially requests the content item, in a migration message from the VDS 160 when the VDS 160 determines that a switch between use of unicast service and eMBMS service for the content item in the serving cell of the UE 102 is warranted while the UE 102 is already receiving the content item, or the like, as well as various combinations thereof). The UEs 102 are configured to support the signaling 181 between the VDS 160 and the UEs 102 (e.g., for use by the UEs 102 in requesting content items, for use by the VDS 160 in dynamically instructing the UEs 102 regarding whether unicast service or eMBMS service is to be used for receiving content items, or the like, as well as various combinations thereof). The UEs 102 may be configured to support various other functions and signaling in order to support dynamic and opportunistic switching between use of unicast service and use of multicast-broadcast service for a content item on a serving cell. It is noted that the operation of UEs 102 may be further understood by way of reference to the example method of FIG. 2.

It will be appreciated that various embodiments of the service switching capability may be further understood by considering the example depicted in FIG. 1. In the example of FIG. 1, for a given video content item, only one of the five UEs 102 depicted as being attached to eNB 110-1 is requesting or receiving the video content item whereas four of the five UEs 102 depicted as being attached to eNB 110-2 are requesting or receiving the video content item. In this example of FIG. 1, it is assumed that the threshold for the number of UEs 102 that need to be requesting or receiving the video content item is three UEs 102 (i.e., three or more UEs 102 receiving or requesting to receive the video content item triggers use of eMBMS service to deliver the video content item). Various embodiments of the service switching capability enable use of eMBMS service to be activated on the eNB 110-2 for delivery of the video content item via the eMBMS service (since, as illustrated, four of the UEs 102 attached via eNB 110-2 are requesting or receiving the video content item) while the video content item continues to be delivered via unicast service on eNB 110-1. It is noted that, in the absence of the service switching capability, both eNBs 110 might be required to deliver the video content item using unicast service (thereby wasting resources on eNB 110-2) or both eNBs 110 might be required to deliver the video content item using eMBMS service (thereby wasting resources on eNB 110-1).

It will be appreciated that the wireless operator (e.g., operating eNBs 110 and EPC 130) and the video delivery operator (e.g., operating VDS 160) may be the same entity or different entities. When the wireless operator and the video delivery operator are the same entity, interfaces between elements of the EPC 130 and the VDS 160 may be standard interfaces or may be proprietary. When the wireless operator and the video delivery operator are the same entity, interfaces between elements of the EPC 130 and the VDS 160 may be standard interfaces or may be agreed to by the different entities (e.g., the wireless operator may expose designated APIs for use by the video delivery operator), special agreements (e.g., service level agreements (SLAs), security level agreements, or the like) may be in place between the entities, or the like, as well as various combinations thereof.

It will be appreciated that, while wireless communication architecture 100 of FIG. 1 is primarily presented with respect to specific types, numbers, and arrangements of elements, wireless communication architecture 100 of FIG. 1 may be adapted to use other types, numbers, or arrangements of elements while still supporting a service switching capability enabling dynamic and opportunistic switching between use of unicast service (e.g., LTE unicast) and use of multicast-broadcast service (e.g., LTE eMBMS) for a content item on a serving cell.

It will be appreciated that, while primarily presented herein within the context of a wireless communication architecture that is based on a particular type of wireless communication network (namely, wireless communication architecture 100 includes a 4G LTE wireless network), various embodiments presented herein may be used within, or may be adapted for use within, various other types of wireless communication networks (e.g., 3G wireless networks, other types of 4G wireless networks, 5G wireless networks, or the like). It will be further appreciated that the implementation of various elements of the wireless communication architecture when the wireless communication architecture is based on such other types of wireless communication networks may be different than as presented with respect to wireless communication architecture 100 of FIG. 1. For example, within a wireless communication architecture that is based on a 5G wireless network, certain elements of the wireless communication architecture may be implemented using a cloud-based deployment involving one or more datacenters (e.g., various elements of the 5G core network (which may be similar to functions of the EPC 130 of the 4G LTE network) may be implemented as virtualized network functions within a datacenter, the VDS 160 may be located within the same datacenter as the virtualized network functions of the 5G core wireless network, or the like, as well as various combinations thereof). Various other implementations of elements of the wireless communication architecture are contemplated.

FIG. 2 depicts a method, based on the wireless communication architecture of FIG. 1, which is configured to support delivery of content to wireless end devices based on unicast services and multicast-broadcast services of a wireless communication network.

It is noted that method 200 of FIG. 2, like the wireless communication architecture of FIG. 1, is described within the context of an LTE based system in which the multicast-broadcast service is the LTE eMBMS service. It is noted that method 200 of FIG. 2 depicts functions performed at the UEs, the BPS/BMSC, and the VDS, which may correspond to the UEs 102 (illustratively, five UEs which are referred to as UEs A1, A2, A3, B, and C), BPS 137/BMSC 135, and VDS 160 of FIG. 1.

It is noted that method 200 of FIG. 2 assumes that two eNBs (referred to as eNB1 and eNB2) are present; however, it will be appreciated that more eNBs (even large numbers of eNBs) may be present.

It is noted that method 200 of FIG. 2 assumes that the signaling between the UEs and the VDS is at the application layer (namely, between the video application clients of the UEs and the video application server of the VDS) using application layer messages.

It is noted that method 200 of FIG. 2 is presented with respect to a particular type of content item (namely, live video content), but may be used for delivery of other types of content (e.g., on-demand video content, audio content, or the like) to wireless end devices based on unicast services and multicast-broadcast services.

It is noted that, although primarily presented within FIG. 2 as being performed serially, at least a portion of the functions of the method 200 of FIG. 2 may be performed contemporaneously or in a different order than as presented in FIG. 2.

At step 205, the BPS/BMSC provisions the eNBs (namely, eNB1 and eNB2) as part of an eMBMS SFN, but the corresponding eMBMS channels are not activated (initialized). This may occur at any time prior to the start of the live video broadcast.

At step 210, UE A1 (served by eNB2) and UEs A2 and A3 (served by eNB1) initially request the live video content from the VDS using unicast connections.

The UEs may request the live video content from the VDS by sending live video content request messages to the VDS, respectively. For example, the UEs may request the live video content from the VDS by requesting the corresponding manifest file for the live video content from the VDS.

The UEs request the video content on a per serving cell basis (e.g., per eNB) and, thus, the VDS determines, for each request from a UE for the live video content, the serving cell identifier of the serving cell with which the UE is associated.

In at least some embodiments, the VDS may determine the serving cell identifier of the serving cell from the live video content request message received from the UE. The UE may be configured to include the serving cell identifier of the serving cell within the live video content request message that is sent to the VDS. The serving cell identifier of the serving cell may be determined by the video application client on the UE. The serving cell identifier of the serving cell may be determined by the video application client on the UE via the operating system API on the UE (e.g., ANDROID, iOS, or the like). The video application client of the UE may place the serving cell identifier within the live video content request message sent to the VDS such that the serving cell identifier is communicated to the VDS at the application layer.

In at least some embodiments, the VDS may determine the serving cell identifier of the serving cell based on information available within the wireless network. The VDS may determine the serving cell identifier of the serving cell, based on information available within the wireless network, based on a determination that the live video content request message received from the UE does not include the serving cell identifier.

In at least some embodiments, the VDS may determine the serving cell identifier of the serving cell based on information available within the wireless network by obtaining input mapping information and processing the input mapping information to obtaining output mapping information. The input mapping information may include: (1) for a set of eNBs (e.g., all of the eNBs in the network, a subset of the eNBs of the network that meet some criteria, or the like), bearer identifiers of bearers served by the eNBs, (2) mappings of bearer identifiers of bearers to UE identifiers of the UEs served by the eNBs, and (3) mappings of UE identifiers of the UEs served by the eNBs to addresses of the UEs (e.g., IP addresses). The output mapping information, which may be determined based on processing or analysis of the input mapping information, may include a mapping of an address of the UE (e.g., IP address) to the serving cell identifier of the serving cell. For example, in the case of an LTE-based network as presented with respect to FIG. 2, the input mapping information may include: (1) the S1AP identifiers of all of the bearers served by eNB1 and eNB2 (which may be obtained from the eNBs), (2) mappings of the S1AP identifiers of all of the bearers served by eNB1 and eNB2 to the UE International Mobile Subscriber Identities (IMSIs) of the UEs (which may be obtained from the MME), and (3) mappings of the UE IMSIs of the UEs to the IP addresses assigned to those UE IMSIs (e.g., which may be obtained from the PGW). For example, in the case of an LTE-based network as presented with respect to FIG. 2, the output mapping information may include a mapping of the IP address of the UE to the serving cell identifier of the serving cell.

In at least some embodiments, the VDS may obtain the input mapping information and/or the output mapping information based on interaction with agent(s) running on the device(s) from which the input mapping is available, which agents may return the input mapping information to the VDS responsive to request(s) by the VDS for the input mapping information. For example, in the case of an LTE-based network as presented with respect to FIG. 2, the agents may be running on the eNBs (for obtaining bearer identifiers of bearers served by the eNBs, such as for obtaining S1AP identifiers in LTE-based networks), the MME (for obtaining mappings of bearer identifiers of bearers to UE identifiers of the UEs served by the eNBs, such as mappings of the S1AP identifiers of all of the bearers served by eNB1 and eNB2 to the UE IMSIs of the UEs), and the P-GW (for obtaining mappings of UE identifiers of the UEs served by the eNBs to addresses of the UEs, such as mappings of the UE IMSIs of the UEs to the IP addresses assigned to those UE IMSIs). In at least some embodiments, such agents may be configured to return the information directly to the VDS for processing. In at least some embodiments, such agent(s) may be one or more Network Insights Function (NIF) agents. In at least some embodiments, the VDS may receive the information from a Network Insights Function (NIF) in the RAN in the form of a tuple: <UE IP address, serving cell ID, serving cell congestion level, UE channel conditions>. In at least some embodiments, the VDS may request the information for a specific UE identified by IP address by sending a message to an NIF agent, the NIF agent may receive per bearer info from eNodeBs (e.g., bearer ID, cell congestion, UE channel conditions, or the like), the NIF agent may query the MME to map the bearer ID to the UE IMSI, the NIF agent may query the PGW to map the IMSI to UE IP address, and the NIF agent may return the correlated information to the VDS. In at least some embodiments, the VDS may request the information for a specific UE identified by IP address by sending a message to an NIF agent, the NIF agent may receive per bearer info from eNodeBs (e.g., bearer ID, cell congestion, UE channel conditions, or the like), the NIF agent may receive bearer ID to UE IMSI mapping information from the MME (e.g., pushed by the MME), the NIF agent may receive IMSI to UE IP address mapping information from the PGW (e.g., pushed by the PGW), and the NIF agent may return the correlated information to the VDS. It will be appreciated that the VDS may obtain the input mapping information and/or the output mapping information in various other ways.

At step 215, the VDS maintains state information associated with the delivery of the live video content to the UEs (namely, UEs A1, A2, and A3).

The state information for the delivery of the live video content may include, for each serving cell, information for use by the VDS in determining whether the live video content is to be supported within the serving cell using unicast service or multicast-broadcast service. For example, state information for the delivery of the live video content may include, for each serving cell, an indication as to whether a multicast-broadcast service is active in the serving cell for the live video content (e.g., whether a multicast-broadcast flow is active in the serving cell for the live video content), an indication of the number of UEs of the serving cell that are receiving or requesting the live video content, or the like, as well as various combinations thereof.

The VDS monitors, for each serving cell, a number of UEs receiving or requesting the live video content via the serving cell. The VDS monitors the number of UEs receiving or requesting the live video content via the serving cell based on service cell identifier information associated with the UEs (which, as indicated above, may be obtained from the UEs or from the wireless network). The VDS monitors the number of UEs receiving or requesting the live video content via the serving cell for determining whether the live video content is to be provided in the serving cell using unicast service or eMBMS service. The VDS may use the number of UEs receiving or requesting the live video content via the serving cell for instructing UEs as to whether the live content is being provided using unicast service or eMBMS service, for triggering switches between use of unicast service and eMBMS service on the serving cell for the live video content (e.g., activating use of eMBMS service in the serving cell for the live video content or deactivating use of eMBMS service in the serving cell for the live video content such that unicast service is used), or the like, as well as various combinations thereof.

The VDS may determine the number of UEs receiving or requesting the live video content via the serving cell responsive to various conditions or events, such as an event that changes or may change the number of UEs receiving or requesting to receive the live video content via the serving cell (e.g., a request from a UE to receive the live video content, an indication that the UE is no longer receiving the live video content, an indication that a UE has migrated into or out of the serving cell, or the like), an event related to delivery of the live video content via the serving cell (a request from the UE to receive a next video segment of the live video content or the like), expiration of a time period, or the like, as well as various combinations thereof.

The VDS determine whether the live video content is to be provided in the serving cell using unicast service or eMBMS service (e.g., for instructing UEs as to whether the live content is being provided using unicast service or eMBMS service, for triggering switches between use of unicast service and eMBMS service on the serving cell for the live video content, or the like), based on the number of UEs receiving or requesting the live video content via the serving cell, based on a threshold (e.g., based on a determination as to whether the number of UEs receiving or requesting the live video content via the serving cell satisfies the threshold). The threshold may be configured to improve or at least to tend to improve use of wireless resources (e.g., the threshold may be equal to or set based on the number of UEs for which use of multicast transmission to deliver the live video content to the UEs saves wireless resources over use of unicast transmissions to deliver the live video content to the UEs). The threshold may be defined and used in various ways (e.g., switching from unicast service to eMBMS service when the number of UEs receiving or requesting the live video content via the serving cell equals the threshold, switching from unicast service to eMBMS service when the number of UEs receiving or requesting the live video content via the serving cell exceeds the threshold, or the like). It will be appreciated that the threshold may be the same for each serving cell or that different thresholds may be used for different serving cells.

In the example of FIG. 2, assume that the threshold for activation of use of the eMBMS service within a serving cell has been set to three (i.e., at least three UEs with the serving cell must be receiving the live video content via unicast service or have requested to receive the live video content via unicast service in order for use of the eMBMS service to be activated for the live video content in the serving cell). With respect to the serving cell provided by eNB1, the VDS determines that eNB1 does not have an eMBMS flow active for the live video content and that the number of UEs receiving the live video content from eNB1 via unicast service or requesting to receive the live video content from eNB1 via unicast service is insufficient for activating use of the eMBMS service on eNB1 for the live video content (only two UEs, UEs A2 and A3, have requested the live video content from the VDS at this point such that the threshold has not been satisfied). Similarly, with respect to the serving cell provided by eNB2, the VDS determines that eNB2 does not have an eMBMS flow active for the live video content and that the number of UEs receiving the live video content from eNB2 via unicast service or requesting to receive the live video content from eNB2 via unicast service is insufficient for activating use of eMBMS on eNB2 for the live video content (only one UE, UE A1, has requested the live video content from the VDS at this point such that the threshold has not been satisfied).

At step 220, the VDS responds to the requests for the live video content from the UEs (namely, UEs A1, A2, and A3). For the serving cell of eNB1, the VDS, based upon the determination (as discussed in step 215) that the eNB1 does not have an eMBMS active flow for the live video content and that the number of UEs receiving or requesting the live video content from eNB1 via unicast service or is insufficient for activating eMBMS on eNB1 (namely, below the threshold of three), responds to UEs A2 and A3 with respective responses that enable the UEs A2 and A3 to start receiving the live video content via LTE unicast. Similarly, for the serving cell of eNB2, the VDS, based upon the determination (as discussed in step 215) that the eNB2 does not have an eMBMS flow active for the live video content and that the number of UEs receiving or requesting the live video content from eNB2 via unicast service or is insufficient for activating eMBMS on eNB2 (namely, below the threshold of three), responds to UE A1 with a response that enables the UE A1 to start receiving the live video content via LTE unicast. The responses to the UEs may be application layer messages. The responses to the UEs may include indications that the UEs are to use unicast service in the serving cell for receiving the live video content. The responses to the UEs may include information for use by the UEs are to obtain the live video content using unicast service (e.g., the manifest file for the live video content (e.g., including the list of URLs for the segment caches from which the UEs are to receive the segments of the live video content, rates of different versions of the live video content that are available, or the like), or other types of information). At this point, all of the UEs served by eNB1 and eNB2 that are receiving the live video content are receiving the live video content via LTE unicast channels, respectively.

At step 225, UE B (served by eNB1) requests the live video content from the VDS using a unicast connection. The UE B may request the live video content from the VDS by sending a live video content request message to the

VDS (e.g., by requesting the corresponding manifest file for the live video content from the VDS). The VDS, based on the request for the live video content from UE B, determines the serving cell identifier of the serving cell with which UE B is associated (e.g., as described herein in step 210).

At step 230, the VDS determines, based on the state information for the delivery of the live video content (which indicates that an eMBMS flow is not active for the live video content on eNB1 and that two UEs are currently receiving the live video content from eNB1 via respective unicast service) and the new request for the live video content from UE B, that the number of UEs receiving or requesting to receive the live video content from eNB1 via unicast service is sufficient for activating use of eMBMS service on eNB1 for the live video content (namely, the threshold of three has been satisfied by the new request for the live video content from UE B) and, thus, decides to activate use of the eMBMS service on eNB1 for the live video content.

At step 235, the VDS, based on the decision to activate use of the eMBMS service on eNB1 for the live video content, instructs the BPS/BMSC to activate use of the eMBMS service on eNB1 for the live video content (e.g., for activation of an eMBMS flow for the live video content).

The VDS may instruct the BPS/BMSC to activate use of the eMBMS service on eNB1 for the live video content by sending an eMBMS activation instruction to the BPS/BMSC. The eMBMS activation instruction may include an indication that use of the eMBMS service is to be activated, an indication of the live video content for which use of the eMBMS service is to be activated, an indication of the serving cell identifier of the serving cell for which the eMBMS service is to be activated for the live video content (namely, the serving cell identifier of the eNB1), or the like, as well as various combinations thereof. The VDS then waits for a response from the BPS/BMSC indicating that use of the eMBMS service has been activated on the eNB1 for the live video content (e.g., that an eMBMS flow has been activated on the eNB1 for the live video content).

The BPS/BMSC receives the eMBMS activation instruction from the VDS and activates use of the eMBMS service on eNB1 for the live video content (e.g., activates the respective eMBMS flow on eNB1 for the live video content, which results in eNB1 transmitting video content over the eMBMS channel). The BPS/BMSC may activate the eMBMS flow on eNB1 for the live video content in any suitable manner. The BMSC of the BPS/BMSC may send an eMBMS control message to the eNB1, where the eMBMS control message may be configured to trigger configuration and activation at eNB1 of the eMBMS flow carrying specific video content. The eNB1 may be configured to use the eMBMS control message from the BMSC as a basis for initiating a request to join the multicast group for the eMBMS flow for the live video content. The eNB1 may be configured to initiate the request to join the multicast group for the eMBMS flow for the live video content based on any suitable multicast join capabilities (e.g., using Internet Group Management Protocol (IGMP), Multicast Listener Discovery (MLD), or the like, as well as various combinations thereof). The BPS/BMSC may activate the eMBMS flow on eNB1 for the live video content in any other suitable manner. The BPS/BMSC, based on activation of the eMBMS flow on eNB1 for the live video content, sends to the VDS an eMBMS activation response indicating that the eMBMS flow has been activated on the eNB1 for the live video content.

The VDS receives the eMBMS activation response from the BPS/BMSC indicating that use of the eMBMS service has been activated on the eNB1 for the live video content (e.g., indicating that the eMBMS flow has been activated on the eNB1 for the live video content). The eMBMS activation response from the BPS/BMSC includes an indication of the eMBMS channel (e.g., eMBMS channel identifier) for the eMBMS flow for the live video content, which may be used by the VDS to enable the UEs of eNB1 to receive the live video content of the eMBMS flow using the eMBMS channel. It is noted that, although primarily presented herein with respect to embodiments in which a single eMBMS flow is activated for the live video content, in at least some embodiments multiple eMBMS flows may be activated for the live video content (e.g., having different video coding rates for use by different UEs having different channel conditions, such that each UE may obtain the live video content via the eMBMS flow best-suited for its associated channel condition).

At step 240, the VDS responds to the request for the live video content from the UE B. The VDS, based on an indication that use of the eMBMS service has been activated on the eNB1 for the live video content (e.g., that the eMBMS flow has been activated on the eNB1 for the live video content), sends a live video content response to the UE B that instructs the UE B to receive the live video content using the eMBMS service (e.g., from the eMBMS flow that has been activated on the eNB1 for the live video content) rather than the unicast service. The live video content response that instructs the UE B to receive the live video content using the eMBMS service may be configured to instruct the UE B to tune to the eMBMS channel that is transporting the eMBMS flow established for the live video content. The live video content response that instructs the UE B to tune to the eMBMS channel established for the live video content may include the eMBMS channel identifier of the eMBMS channel established for the live video content. The live video content response that instructs the UE B to tune to the eMBMS channel established for the live video content may be an application layer message. The UE B receives the live video content response from the VDS and obtains the live video content via the eMBMS flow of the eMBMS channel.

The live video content response that instructs the UE B to receive the live video content using the eMBMS service may be sent from the VDS to the UE B in various ways. In at least some embodiments, the live video content response that instructs the UE B to receive the live video content using the eMBMS service may be sent using one or more HTTP header extensions (e.g., the Third Generation Partnership Project (3GPP) Technical Specification (TS) 26.346 MooD header, with or without additional extension fields). In at least some embodiments, custom HTTP headers carrying extensions may be used. In at least some embodiments (e.g., when the wireless service provider also owns or controls the VDS), the communication between the VDS and the UE B may be via a custom UE video player application and the messages exchanged between the VDS and the UE B (e.g., the request for the live video content and this associated response) may be application specific.

The live video content response that instructs the UE B to receive the live video content using the eMBMS service may include various types of information for use by the UE B in obtaining the live video content via the eMBMS channel. For example, as discussed above, the live video content response may include the eMBMS channel identifier of the eMBMS channel supporting the eMBMS flow for the live video content. For example, the live video content response may include additional information configured for use by the UE B to improve or optimize use of the eMBMS service to obtain the live video content (e.g., the manifest file for the live video content (e.g., including the list of URLs for the segment caches from which the UEs are to receive the segments of the live video content, rates of different versions of the live video content that are available, or the like), or other types of information). The live video content response that instructs the UE B to receive the live video content using the eMBMS service may include various other types of information for use by the UE B in obtaining the live video content via the eMBMS service.

The UE B receives the live video content response from the VDS and obtains the live video content via the eMBMS flow of the eMBMS channel. The UE B may obtain the live video content by tuning to the eMBMS channel to start receiving the live video content via the eMBMS flow of the eMBMS channel. The UE B may obtain the live video content by instantiating, locally on the UE B, a local proxy video content server associated with the buffered video segments of the live video content that are received via the eMBMS flow of the eMBMS channel so that the manifest file for the live video content is manipulated or generated locally on the UE B in order to alter the standard behavior of the UE B to ensure that usage of multicast objects is favored over usage of unicast objects, such that the video player of the UE B then starts requesting the video content from the local proxy video content server instead of from the VDS.

At step 245, the VDS, based on an indication that use of the eMBMS service has been activated on the eNB1 for the live video content, instructs other UEs receiving the live video content via eNB1 (namely, the UEs A2 and A3 that are already receiving the live video content via respective unicast channels of the unicast service) to switch from receiving the live video content via the unicast service (e.g., via respective unicast channels of the unicast service) to receiving the live video content via the eMBMS service (e.g., via the eMBMS flow of the eMBMS channel of the eMBMS service). The service switch instructions that instruct the UEs A2 and A3 to switch from receiving the live video content via the unicast service to receiving the live video content via the eMBMS service may be configured to instruct the UE B to tune to the eMBMS channel supporting the eMBMS flow for the live video content. The service switch instructions that instruct the UEs A2 and A3 to switch from receiving the live video content via the unicast service to receiving the live video content via the eMBMS service may include the eMBMS channel identifier of the eMBMS channel supporting the eMBMS flow for the live video content. The service switch instructions that instruct the UEs A2 and A3 to switch from receiving the live video content via the unicast service to receiving the live video content via the eMBMS service may be an application layer message. The UEs A2 and A3 receive the respective service switch instructions from the VDS and switch to obtaining the live video content via the eMBMS service.

The service switch instructions that instruct the UEs A2 and A3 to switch from receiving the live video content via the unicast service to receiving the live video content via the eMBMS service may be sent from the VDS to the UEs A2 and A3 in various ways. In at least some embodiments, the service switch instructions that instruct the UEs A2 and A3 to switch from receiving the live video content via the unicast service to receiving the live video content via the eMBMS service may be sent using one or more HTTP header extensions (e.g., 3GPP TS 26.346 MooD headers, with or without additional extension fields). In at least some embodiments, custom HTTP headers carrying extensions may be used. In at least some embodiments (e.g., when the wireless service provider also owns or controls the VDS), the communication between the VDS and the UE (e.g., UE A2 or UE A3) may be via a custom UE video player application and the messages exchanged between the VDS and the UE (e.g., the request for the live video content, the associated response that initially instructed the UE to use the unicast service, and the service switch instruction) may be application specific.

The service switch instructions that instruct the UEs A2 and A3 to switch from receiving the live video content via the unicast service to receiving the live video content via the eMBMS service may include various types of information for use by the UEs A2 and A3 in obtaining the live video content via the eMBMS channel. For example, as discussed above, the service switch instructions may include the eMBMS channel identifier of the eMBMS channel supporting the eMBMS flow for the live video content. For example, the service switch instructions may include additional information configured for use by the UEs A2 and A3 for smooth and seamless switchover from use of the unicast service to obtain the live video content to use of the eMBMS service to obtain the live video content (e.g., the video rate available via the eMBMS channel or the like). The service switch instructions that instruct the UEs A2 and A3 to switch from receiving the live video content via the unicast service to receiving the live video content via the eMBMS service may include various other types of information for use by the UEs A2 and A3 in obtaining the live video content via the eMBMS service.

The UEs A2 and A3 receive the service switch instructions from the VDS and obtain the live video content via the eMBMS flow of the eMBMS channel. The UEs A2 and A3 may obtain the live video content by tuning to the eMBMS channel to start receiving the live video content via the eMBMS flow of the eMBMS channel. The UEs A2 and A3 may obtain the live video content by instantiating, locally on the UEs A2 and A3, respective local proxy video content servers associated with the buffered video segments of the live video content that are received via the eMBMS flow of the eMBMS channel so that the manifest file for the live video content is manipulated or generated locally on the UEs A2 and A3 in order to alter the standard behavior of the UEs A2 and A3 to ensure that usage of multicast objects is favored over usage of unicast objects, such that the respective video players of the UEs A2 and A3 then starts requesting the video content from the respective local proxy video content servers instead of from the VDS.

At step 250, UE C (served by eNB1) requests the live video content from the VDS using a unicast connection. The UE C may request the live video content from the VDS by sending a live video content request message to the VDS (e.g., by requesting the corresponding manifest file for the live video content from the VDS). The VDS, based on the request for the live video content from UE C, determines the serving cell identifier of the serving cell with which UE C is associated (e.g., as described herein in step 210).

At step 255, the VDS determines that use of the eMBMS service is already active in the serving cell for the live video content. The VDS may determine that use of the eMBMS service is already active in the serving cell for the live video content based on state information maintained at the VDS, based on interaction with the BPS/BMSC, or the like.

At step 260, the VDS responds to the request for the live video content from the UE C. The VDS, based on an indication that use of the eMBMS service is active on the eNB1 for the live video content, sends a live video content response to the UE C that instructs the UE C to receive the live video content using the eMBMS service (e.g., from the eMBMS flow that has been activated on the eNB1 for the live video content) rather than the unicast service. The live video content response that instructs the UE C to receive the live video content using the eMBMS service may be configured to instruct the UE C to tune to the eMBMS channel supporting the eMBMS flow for the live video content. The live video content response that instructs the UE C to tune to the eMBMS channel supporting the eMBMS flow for the live video content may include the eMBMS channel identifier of the eMBMS channel supporting the eMBMS flow for the live video content. The live video content response that instructs the UE C to tune to the eMBMS channel supporting the eMBMS flow for the live video content may be an application layer message. The live video content response that instructs the UE C to receive the live video content using the eMBMS service may be sent from the VDS to the UE C in various ways (e.g., as discussed for the UE B in conjunction with step 240). The live video content response that instructs the UE C to receive the live video content using the eMBMS service may include various types of information for use by the UE C in obtaining the live video content via the eMBMS channel supporting the eMBMS flow (e.g., as discussed for the UE B in conjunction with step 240). The UE C receives the live video content response from the VDS and obtains the live video content via the eMBMS flow of the eMBMS channel. The UE C may obtain the live video content by tuning to the eMBMS channel to start receiving the live video content via the eMBMS flow of the eMBMS channel (e.g., as discussed for UE B in conjunction with step 240).

It is noted that, for purposes of clarity, method 200 is assumed to end at this point. However, it will be appreciated that method 200 may continue to operate for monitoring the number of UEs of the serving cell that are receiving or requesting the live video content and dynamically switching between use of unicast service for delivering the live video content to UEs in the serving cell and use of eMBMS for delivering the live video content to UEs in the serving cell. The VDS may continue to monitor the number of UEs of the serving cell that are receiving or requesting the live video content. The VDS, as indicated above, may continue to monitor the number of UEs of the serving cell that are receiving or requesting the live video content based on messages received from the UEs. The UEs may provide the VDS (e.g., periodically, responsive to events or conditions, or the like) with information such as whether or not the UEs are still participating in the eMBMS for the live video content, the serving cell identifiers of the serving cells with which the UEs are currently associated, or the like, as well as various combinations thereof. The UEs may provide such information using application layer messages (e.g., using video segment request messages by which the UEs request video segments of the live video content from the VDS, signaling messages dedicated for use by the UEs to provide such information (e.g., reporting messages, keep-alive message or other similar types of messages), or the like, as well as various combinations thereof). The VDS, based on a determination that the number of UEs of the serving cell that are receiving or requesting the live video content on the serving cell no longer warrants use of the eMBMS for the live video content, may instruct the BPS/BMSC to deactivate use of the eMBMS service on the serving cell and instruct the UEs that are participating in the eMBMS for the live video content to switch to use of unicast service to receive the live video content. It will be appreciated that the VDS may determine the UEs that are participating in the eMBMS service for the live video content in various ways (e.g., by maintaining state information regarding participation of UEs in the eMBMS service for the live video content, based on periodic reporting by the UEs (e.g., UEs may report participation in the eMBMS service for the live video content in various ways, such as via application level messages to the VDS, via messages to the BPS/BMSC which may then report UE participation in the eMBMS service to the VDS, or the like, as well as various combinations thereof), or the like, as well as various combinations thereof).

It will be appreciated that, although embodiments of the service switching capability are primarily presented herein within the context of support for switching between use of unicast service and use of multicast-broadcast service for a particular type of content (namely, video content), various embodiments of the service switching capability may be configured to support switching between use of unicast service and use of multicast-broadcast service for various other types of content and, therefore, references herein to “video content” (and related terms) may be read more generally as being references to “content” (and related terms, respectively, which may include terms such as content delivery system, content application client, content application server, or the like).

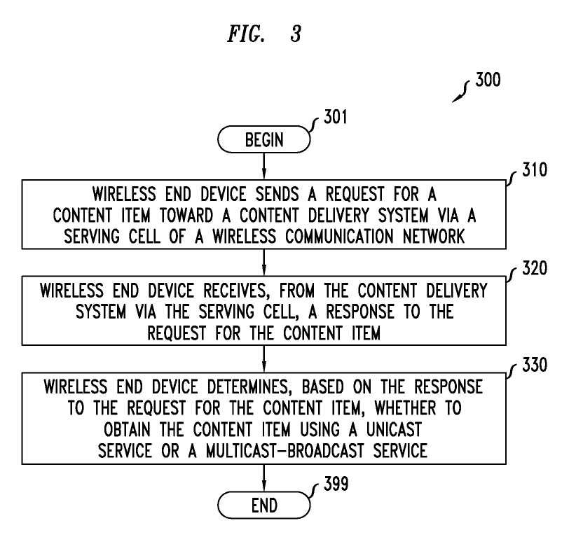

FIG. 3 depicts a method for use by a wireless end device in supporting delivery of content to the wireless end device based on unicast services and multicast-broadcast services of a wireless communication network. It will be appreciated that, although primarily presented in FIG. 3 as being performed serially, at least a portion of the functions of method 300 may be performed contemporaneously or in a different order than as presented in FIG. 3. At block 301, method 300 begins. At block 310, the wireless end device sends a request for a content item toward a content delivery system via a serving cell of a wireless communication network. At block 320, the wireless end device receives, from the content delivery system via the serving cell, a response to the request for the content item. At block 330, the wireless end device determines, based on the response to the request for the content item, whether to obtain the content item using a unicast service or a multicast-broadcast service. At block 399, method 300 ends. It will be appreciated that method 300 of FIG. 3 may be adapted to include various other blocks associated with various other functions which may be supported by the wireless end device (e.g., functions presented with respect to FIG. 1 and/or FIG. 2).

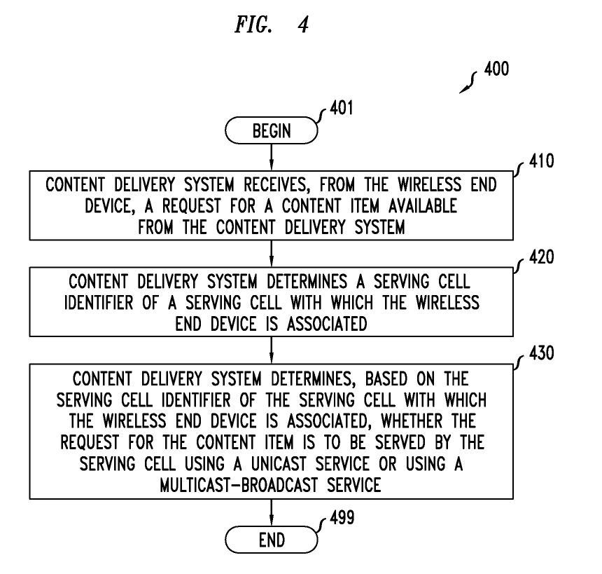

FIG. 4 depicts a method for use by a content delivery system in supporting delivery of content to a wireless end device based on unicast services and multicast-broadcast services of a wireless communication network. It will be appreciated that, although primarily presented in FIG. 4 as being performed serially, at least a portion of the functions of method 400 may be performed contemporaneously or in a different order than as presented in FIG. 4. At block 401, method 400 begins. At block 410, the content delivery system receives, from the wireless end device, a request for a content item available from the content delivery system. At block 420, the content delivery system determines a serving cell identifier of a serving cell with which the wireless end device is associated. At block 430, the content delivery system determines, based on the serving cell identifier of the serving cell with which the wireless end device is associated, whether the request for the content item is to be served by the serving cell using a unicast service or using a multicast-broadcast service. At block 499, method 400 ends. It will be appreciated that method 400 of FIG. 4 may be adapted to include various other blocks associated with various other functions which may be supported by the wireless end device (e.g., functions presented with respect to FIG. 1 and/or FIG. 2).

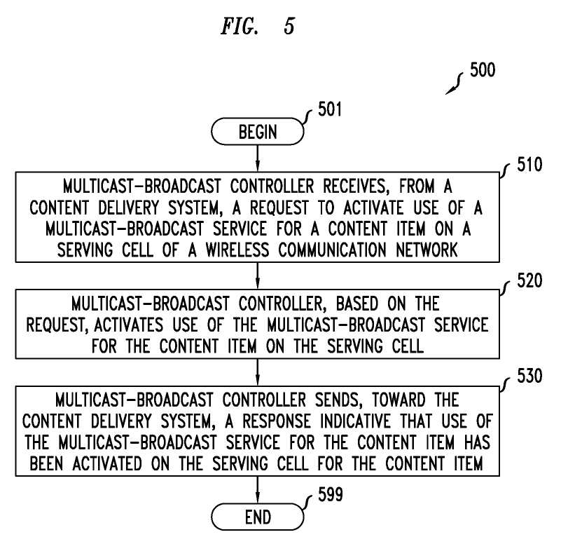

FIG. 5 depicts a method for use by a multicast-broadcast controller in supporting delivery of content to a wireless end device based on unicast services and multicast-broadcast services of a wireless communication network. It will be appreciated that, although primarily presented in FIG. 5 as being performed serially, at least a portion of the functions of method 500 may be performed contemporaneously or in a different order than as presented in FIG. 5. At block 501, method 500 begins. At block 510, the multicast-broadcast controller receives, from a content delivery system, a request to activate use of a multicast-broadcast service for a content item on a serving cell of a wireless communication network. This may be a request to activate a multicast-broadcast flow for the content item. At block 520, the multicast-broadcast controller, based on the request, activates use of the multicast-broadcast service for the content item on the serving cell. This may be activation of a multicast-broadcast flow for the content item. At block 530, the multicast-broadcast controller sends, toward the content delivery system, a response indicative that use of the multicast-broadcast service for the content item has been activated on the serving cell for the content item. At block 599, method 500 ends. It will be appreciated that method 500 of FIG. 5 may be adapted to include various other blocks associated with various other functions which may be supported by the wireless end device (e.g., functions presented with respect to FIG. 1 and/or FIG. 2).

It will be appreciated that, although primarily presented herein with respect to embodiments in which the VDS controls use of unicast service or multicast-broadcast service by wireless end devices (e.g., the VDS instructs the wireless end devices regarding the type of service to use and the wireless end devices follow the instructions of the VDS), in at least some embodiments wireless end devices may have at least some level of control over use of unicast service or multicast-broadcast service. In at least some embodiments, for example, wireless end devices may be configured to decide to use unicast service even when the multicast-broadcast service is active within the serving cell. This may be at the discretion of the wireless end devices, or may only be permitted when the wireless end device satisfies a particular condition for use of unicast service even when the multicast-broadcast service is active within the serving cell (e.g., the UE is an older device running a newer video player application and does not support eMBMS, the UE is in poor channel conditions such that it cannot receive in time file segments for the video resolution/bitrate that is used for eMBMS transmission, or the like). It will be appreciated that wireless end devices may be configured to support other functions which provide the wireless end devices with at least some level of control over whether to use unicast service or multicast-broadcast service for a particular content item.

It will be appreciated that various embodiments of the service switching capability may provide various advantages or potential advantages. For example, the service switching capability may be obviate a need for multicast-broadcast service to be statically configured within each serving cell for a video stream regardless of the number of wireless end devices in the serving cells that are actually receiving the video stream (which wastes resources on any serving cells that have a small number of wireless end devices (or even no wireless end devices) receiving the video stream). For example, the service switching capability may ensure that the multicast-broadcast service is used within a cell when it is economically feasible or desirable to do so, such as when a sufficient number of wireless end devices of the cell are viewing the video stream (e.g., use of eMBMS may be economically feasible or desirable within a cell when a sufficient number of wireless end devices of the cell are viewing the video stream, since transmitting over unicast channels may unnecessarily waste cell wireless resources to deliver identical video content to different users over separate unicast channels and since transmitting over the eMBMS channel takes away shared wireless resources from the unicast user sessions in the cell). It will be appreciated that various embodiments of the service switching capability may provide various other advantages or potential advantages.

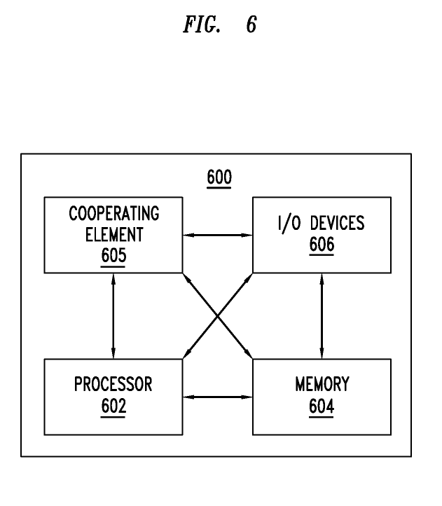

FIG. 6 depicts a high-level block diagram of a computer suitable for use in performing various functions described herein.

The computer 600 includes a processor 602 (e.g., a central processing unit (CPU), a processor having a set of processor cores, a processor core of a processor, or the like) and a memory 604 (e.g., a random access memory (RAM), a read only memory (ROM), or the like). The processor 602 and the memory 604 are communicatively connected.

The computer 600 also may include a cooperating element 605. The cooperating element 605 may be a hardware device. The cooperating element 605 may be a process that can be loaded into the memory 604 and executed by the processor 602 to implement functions as discussed herein (in which case, for example, the cooperating element 605 (including associated data structures) can be stored on a non-transitory computer-readable storage medium, such as a storage device or other storage element (e.g., a magnetic drive, an optical drive, or the like)).

The computer 600 also may include one or more input/output devices 606. The input/output devices 606 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 600 of FIG. 6 may represent a general architecture and functionality suitable for implementing functional elements described herein, portions of functional elements described herein, or the like, as well as various combinations thereof. For example, computer 600 may provide a general architecture and functionality that is suitable for implementing one or more of a UE 102, an eNB 110, an element of BN 120, an element of EPC 130, an element of BN 140, an element of PDN 150, VDS 160, an element of CP 170, or the like.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive, by a content delivery system from a wireless end device, a request for a content item available from the content delivery system;
determine, by the content delivery system, a serving cell identifier of a serving cell with which the wireless end device is associated; and
determine, by the content delivery system based on the serving cell identifier of the serving cell with which the wireless end device is associated, whether the request for the content item is to be served by the serving cell using a unicast service or using a multicast-broadcast service.

2. The apparatus of claim 1, wherein the request for the content item comprises a request for a manifest file of the content item.

3. The apparatus of claim 1, wherein, to determine the serving cell identifier of the serving cell, the processor is configured to:
retrieve the serving cell identifier of the serving cell from the request for the content item.

4. The apparatus of claim 1, wherein, to determine the serving cell identifier of the serving cell, the processor is configured to:
obtain input mapping information from one or more elements of the wireless communication network; and
determine, based on the input mapping information, an output mapping between an address of the wireless end device and the serving cell identifier of the serving cell.

5. The apparatus of claim 4, wherein the input mapping information comprises:
for each of one or more wireless access nodes, bearer identifiers of bearers served by the respective one or more wireless access nodes;
mappings of bearer identifiers of bearers to wireless end device identifiers of wireless end devices served by the one or more wireless access nodes; and
mappings of wireless end device identifiers of wireless end devices to addresses of the wireless end devices.

6. The apparatus of claim 1, wherein, to determine whether the request for the content item is to be served by the serving cell using the unicast service or using the multicast-broadcast service, the processor is configured to:
determine, based on the serving cell identifier of the serving cell, whether the multicast-broadcast service is active within the serving cell for the content item.

7. The apparatus of claim 6, wherein the processor is configured to determine whether the multicast-broadcast service is active within the serving cell for the content item based on at least one of local state information maintained by the content delivery system or a query by the content delivery system to a multicast broadcast system of the wireless communication network.

8. The apparatus of claim 6, wherein the processor is configured to:
send, from the content delivery system toward the wireless end device based on a determination that the multicast-broadcast service is active within the serving cell for the content item, a response including a multicast-broadcast channel identifier of the multicast-broadcast service for the content item.

9. The apparatus of claim 6, wherein the processor is configured to:
determine, by the content delivery system based on a determination that the multicast-broadcast service is not active within the serving cell for the content item, a number of wireless end devices of the serving cell receiving or requesting the content item.

10. The apparatus of claim 1, wherein, to determine whether the request for the content item is to be served by the serving cell using the unicast service or using the multicast-broadcast service, the processor is configured to:
determine, by the content delivery system, a number of wireless end devices of the serving cell receiving or requesting the content item; and
determine, based on the number of wireless end devices of the serving cell receiving or requesting the content item, whether the request for the content item is to be served by the serving cell using the unicast service or using the multicast-broadcast service.

11. The apparatus of claim 10, wherein the processor is configured to:
send, by the content delivery system toward the wireless end device based on a determination that the request for the content item is to be served by the serving cell using the unicast service, a response indicative that the request for the content item is to be served by the serving cell using the unicast service.

12. The apparatus of claim 10, wherein the processor is configured to:
initiate, by the content delivery system based on a determination that the request for the content item is to be served by the serving cell using the multicast-broadcast service, activation of use of the multicast-broadcast service in the serving cell for the content item.

13. The apparatus of claim 12, wherein, to initiate activation of use of the multicast-broadcast service in the serving cell for the content item, the processor is configured to:
send, from the content delivery system toward a multicast-broadcast controller of the wireless communication network, a request for activation of use of the multicast-broadcast service in the serving cell for the content item.

14. The apparatus of claim 13, wherein the processor is configured to:
receive, by the content delivery system from the multicast-broadcast controller, a response indicative that use of the multicast-broadcast service has been activate in the serving cell for the content item, wherein the response includes a multicast-broadcast channel identifier for a multicast-broadcast channel including a multicast-broadcast flow transporting the content item.

15. The apparatus of claim 14, wherein the processor is configured to:
send, from the content delivery system toward the wireless end device, a response to the request for the content item, wherein the response to the request for the content item includes the multicast-broadcast channel identifier for the multicast-broadcast channel including the multicast-broadcast flow transporting the content item.

16. The apparatus of claim 14, wherein the processor is configured to:
send, from the content delivery system toward a second wireless end device associated with the serving cell, an instruction for the second wireless end device to switch from using the unicast service for the content item to using the multicast-broadcast service for the content item.

17. The apparatus of claim 1, wherein the processor is configured to:
determine, based on an event, a number of wireless end devices of the serving cell receiving or requesting the content item.

18. The apparatus of claim 17, wherein the event comprises a second request for the content item from a second wireless end device, an indication from a second wireless end device that the second wireless end device is no longer interested in receiving the content item, an indication that a second wireless end device has migrated into or out of the serving cell, or a request for a segment of the content item.

19. The apparatus of claim 17, wherein the processor is configured to:
initiate, by the content delivery system based on the number of wireless end devices of the serving cell receiving or requesting the content item, deactivation of use of the multicast-broadcast service in the serving cell for the content item.

20. An apparatus, comprising:
a processor and a memory communicatively connected to the processor, the processor configured to:
receive, at a multicast-broadcast controller from a content delivery system, a request to activate use of a multicast-broadcast service for a content item on a serving cell of a wireless communication network;
activate, by the multicast-broadcast controller based on the request, use of the multicast-broadcast service for the content item on the serving cell; and
send, from the multicast-broadcast controller toward the content delivery system, a response indicative that use of the multicast-broadcast service for the content item has been activated on the serving cell for the content item.

21. The apparatus of claim 20, wherein the request to activate use of the multicast-broadcast service for the content item on the serving cell comprises a serving cell identifier of the serving cell.

22. The apparatus of claim 20, wherein the response includes an indication of a multicast-broadcast channel identifier for a multicast-broadcast channel including a multicast-broadcast flow transporting the content item.

23. The apparatus of claim 20, wherein the processor is configured to:
receive, at the multicast-broadcast controller from the content delivery system, a request to deactivate use of the multicast-broadcast service for the content item on the serving cell;
deactivate, by the multicast-broadcast controller, use of the multicast-broadcast service for the content item on the serving cell; and
send, from the multicast-broadcast controller toward the content delivery system, a response indicative that use of the multicast-broadcast service for the content item has been deactivated on the serving cell for the content item.

24. An apparatus, comprising:
a processor and a memory communicatively connected to the processor, the processor configured to:
send, from a wireless end device toward a content delivery system via a serving cell of a wireless communication network, a request for a content item;
receive, by the wireless end device from the content delivery system via the serving cell, a response to the request for the content item; and
determine, by the wireless end device based on the response to the request for the content item, whether to obtain the content item using a unicast service or a multicast-broadcast service.

25. The apparatus of claim 24, wherein the request for the content item comprises a serving cell identifier of the serving cell.

26. The apparatus of claim 25, wherein the processor is configured to:
determine the serving cell identifier of the serving cell from a content application client of the wireless end device.

27. The apparatus of claim 24, wherein the response to the request for the content item comprises an indication that the wireless end device is to use the multicast-broadcast service to obtain the content item.

28. The apparatus of claim 27, wherein the processor is configured to:
select use of the unicast service to obtain the content item based on at least one of capability information associated with the wireless end device or channel condition information associated with the wireless end device.

29. The apparatus of claim 27, wherein the response to the request for the content item comprises a multicast-broadcast channel identifier for a multicast-broadcast channel including a multicast-broadcast flow transporting the content item.

30. The apparatus of claim 24, wherein the response to the request for the content item comprises an indication that the wireless end device is to use the unicast service to obtain the content item.

31. The apparatus of claim 30, wherein the processor is configured to:
send, from the wireless end device toward the content delivery system, a request for a next segment of the content item, wherein the request for the next segment of the content item comprises a serving cell identifier of the serving cell.

32. An apparatus, comprising:
a processor and a memory communicatively connected to the processor, the processor configured to:
determine, by a wireless end device associated with a serving cell of a wireless communication system and including a content application client, a serving cell identifier of the serving cell; and
send, from the wireless end device toward a content delivery system including a content application server, a content application message comprising an indication of the serving cell identifier of the serving cell.
